(19) United States
(12) Patent Application Publication
(10) Pub. No.: US 2026/0354619 A1
(43) Pub. Date: Nov. 12, 2026

(54) HEAT-RESISTANT CONTAINER AND COOKING METHOD

(71) Applicant: HOSOKAWA YOKO CO., LTD., Chiyoda-ku, Tokyo (JP)

(72) Inventors: Yoshihiro TAKEUCHI, Chiyoda-ku, Tokyo (JP); Yohei KAGEYAMA, Chiyoda-ku, Tokyo (JP)

(21) Appl. No.: 19/123,984

(22) PCT Filed: Nov. 9, 2023
(86) PCT No.: PCT/JP2023/040329

§ 371 Date: Apr. 24, 2025

(30) Foreign Application Priority Data
Nov. 11, 2022 (JP) 2022-180735

(51) Int. Cl. A47J 36/04; B65D 81/34

(52) U.S. Cl. CPC A47J 36/04; B65D 81/34

(57) ABSTRACT

An object is to provide a heat seal layer-forming resin composition that can form a heat seal layer having excellent heat resistance and heat seal properties and that has excellent film forming properties, and a film containing this heat seal layer-forming resin composition. As a solving means, there is provided a heat seal layer-forming resin composition containing a crystalline polyethylene terephthalate-based resin and an epoxy group-containing styrene-(meth)acrylic acid ester-based resin, in which the content of the epoxy group-containing styrene-(meth)acrylic acid ester-based resin relative to 100 parts by mass of the crystalline polyethylene terephthalate-based resin is 0.1 to 0.9 parts by mass.

### TECHNICAL FIELD

The present invention relates to a heat-resistant container and a cooking method. In particular, it relates to a heat-resistant container at least part of which is constituted by a container-forming material having a specific heat seal layer, and a cooking method that involves heating the ingredients by using this heat-resistant container.

### BACKGROUND ART

Lifestyle changes that have occurred in recent years have increased the proportion of people refraining from eating out and preparing meals at home, and have boosted the popularity of camping and spending a night in the car. Under such trends, there has been a growing demand for heat-resistant containers that provide a cooking method that can save the trouble of washing cookware such as pots, cleaning the kitchen, etc.

PTL 1 discloses a pouch that uses a laminate having a heat seal layer and that has a storage portion inside created by bonding peripheral portions while arranging the heat seal layers to face each other. With this pouch, ingredients such as meat can be put in the storage portion and cooked by using a microwave oven or by boiling. In this manner, cooking can be carried out while saving the trouble of washing cookware such as pots, cleaning the kitchen, etc.

### CITATION LIST

### Patent Literature

PTL 1: Japanese Patent No. 6880966

### SUMMARY OF INVENTION

### Technical Problem

The pouch described in PTL 1 is useful when the pouch is used in microwave cooking or boiling. However, for example, when cooking such as stir-frying or deep-frying is to be carried out inside the pouch by placing the pouch on a pot, a frying pan, or the like placed on a gas stove, deficient heat resistance of the pouch-constituting material may lead to failures such as melting and perforation of the pouch, and thus such use has not been possible.

Thus, there is a demand for a heat-resistant container that has heat resistance enabling cooking such as stir-frying or deep-frying by placing the container on cookware such as a pot or a frying pan directly on the fire. Moreover, such a heat-resistant container has been required to be produced by a simple means such as heat sealing.

A problem to be solved by the present invention is to provide a heat-resistant container that has heat resistance enabling cooking by placing the container on cookware such as a pot or a frying pan directly on the fire and that can be produced by a simple means such as heat sealing.

A problem to be solved by the present invention is to provide a cooking method that enables cooking, such as stir-frying or deep-frying, on cookware such as a pot or a frying pan directly on the fire and that can save the trouble of washing the cookware, cleaning the kitchen, etc.

### Solution to Problem

The inventors of the present invention have conducted extensive studies and found that the aforementioned problem can be solved by the features described below, and thus the present invention has been completed.
[Item 1] A heat-resistant container at least part of which is constituted by a container-forming material having a heat seal layer, in which
   the heat seal layer contains a heat seal layer-forming resin composition, and
   the heat seal layer-forming resin composition contains a crystalline polyethylene terephthalate-based resin and an epoxy group-containing styrene-(meth)acrylic acid ester-based resin, and a content of the epoxy group-containing styrene-(meth)acrylic acid ester-based resin relative to 100 parts by mass of the crystalline polyethylene terephthalate-based resin is 0.1 parts by mass or more and 0.9 parts by mass or less.
[Item 2] The heat-resistant container described in Item 1, in which
   the heat seal layer-forming resin composition contains a polybutylene terephthalate-based resin, and a content of the polybutylene terephthalate-based resin relative to 100 parts by mass of the crystalline polyethylene terephthalate-based resin is less than 30 parts by mass.
[Item 3] The heat-resistant container described in Item 1 or 2, in which
the crystalline polyethylene terephthalate-based resin
   has a crystal fusion peak temperature of 220 °C or more and 270 °C or less, and/or
   has an intrinsic viscosity at 25 °C of 0.65 dl/g or more and 0.9 dl/g or less.
[Item 4] The heat-resistant container described in Item 1 or 2, in which the container-forming material is a laminate having the heat seal layer and a substrate layer, and the substrate layer includes at least one layer selected from the group consisting of a biaxially stretched polyester-based resin layer, a paper layer, a metal vapor-deposited biaxially stretched polyester-based resin layer, and a metal foil layer.
[Item 5] A cooking method including performing cooking using the heat-resistant container described in Item 4.

### Advantageous Effects of Invention

According to the present invention, a heat-resistant container that has heat resistance enabling cooking by placing the container on cookware such as a pot or a frying pan directly on the fire and that can be produced by a simple means such as heat sealing is provided.

According to the present invention, a cooking method that enables cooking, such as stir-frying or deep-frying, on cookware such as a pot or a frying pan directly on the fire and that can save the trouble of washing the cookware, cleaning the kitchen, etc., is provided.

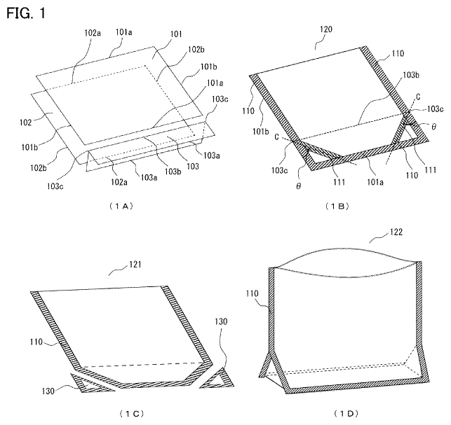

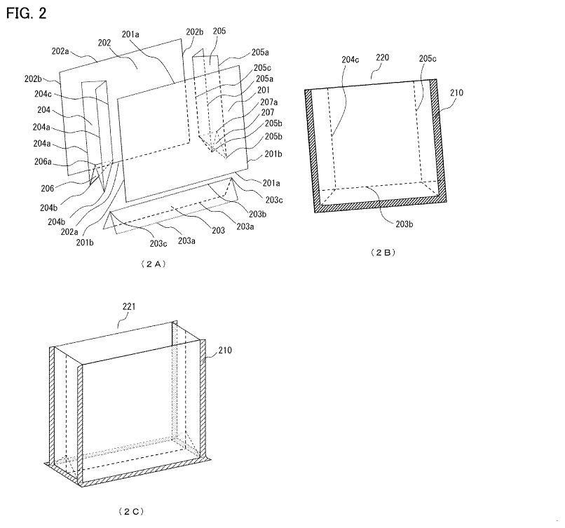

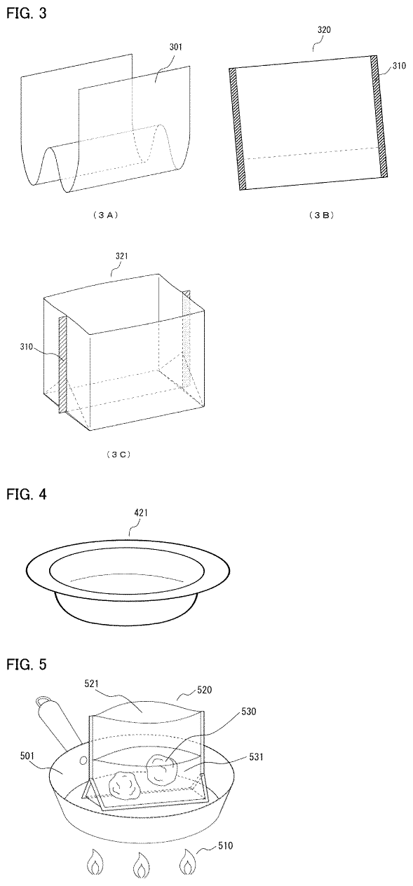

### BRIEF DESCRIPTION OF DRAWINGS

[FIG. 1] Schematic diagrams of a first heat-resistant bag of one embodiment of the heat-resistant container according to the present invention.

[FIG. 2] Schematic diagrams of a second heat-resistant bag of one embodiment of the heat-resistant container according to the present invention.

[FIG. 3] Schematic diagrams of a third heat-resistant bag of one embodiment of the heat-resistant container according to the present invention.

[FIG. 4] A schematic diagram of a heat-resistant dish of one embodiment of the heat-resistant container according to the present invention.

[FIG. 5] A schematic diagram of a cooking method that uses the first heat-resistant bag of one embodiment of the heat-resistant container according to the present invention.

### DESCRIPTION OF EMBODIMENTS

A heat-resistant container and a cooking method of the present invention will be described in detail below.

### [Heat-Resistant Container]

A heat-resistant container according to the present invention is a heat-resistant container at least part of which is constituted by a container-forming material having a specified heat seal layer, in which the specified heat seal layer contains a specified heat seal layer-forming resin composition, the specified heat seal layer-forming resin composition contains a crystalline polyethylene terephthalate-based resin and an epoxy group-containing styrene-(meth)acrylic acid ester-based resin, and a content of the epoxy group-containing styrene-(meth)acrylic acid ester-based resin relative to 100 parts by mass of the crystalline polyethylene terephthalate-based resin is 0.1 parts by mass or more and 0.9 parts by mass or less.

### <Heat Seal Layer of Container-Forming Material>

The heat seal layer in the container-forming material constituting at least part of the heat-resistant container of the present invention contains a specified heat seal layer-forming resin composition.

### (Heat Seal Layer-Forming Resin Composition)

The heat seal layer-forming resin composition contains a crystalline polyethylene terephthalate-based resin and an epoxy group-containing styrene-(meth)acrylic acid ester-based resin, and the content of the epoxy group-containing styrene-(meth)acrylic acid ester-based resin relative to 100 parts by mass of the crystalline polyethylene terephthalate-based resin is 0.1 parts by mass or more and 0.9 parts by mass or less.

The heat seal layer-forming resin composition may further contain less than 30 parts by mass of a polybutylene terephthalate-based resin relative to 100 parts by mass of the crystalline polyethylene terephthalate-based resin.

The heat seal layer-forming resin composition has a crystallinity X_{c} of, for example, 6.0% or more, for example, 11.5% or less, and preferably 9.5% or less. The crystallinity X_{c} is determined from equation (1) below by using the enthalpy of fusion ΔHₘ (J/g) and enthalpy of crystallization ΔH_{CL} (J/g) detected during the first heating cycle of heating to a crystal fusion peak temperature or higher at 10 °C/minute in differential scanning calorimetry (DSC);

X_{c}=100×(ΔHₘ−ΔH_{CL}/140(J/g) (1)

(In the equation, 140 is the heat of perfect crystallization (J/g) of polyethylene terephthalate (PET)).

The heat seal layer-forming resin composition can form a heat seal having a heat seal strength capable of hermetically sealing the content when a heat seal layer containing the heat seal layer-forming resin composition is interposed between adherends or heat seal layers containing the heat seal layer-forming resin composition are stacked, the heat seal layer is heated to a temperature equal to or higher than the crystallization temperature (about 130 °C) of the crystalline polyethylene terephthalate-based resin to enhance interlocking by thermal molecular motions of amorphous sites, and then the heat seal layer is cooled and solidified.

For example, a heat seal having a peel strength of 3N or more per heat seal width of 15 mm at a heat seal temperature of 170 °C and a peel strength of 3N or more per heat seal width of 15 mm at a heat seal temperature of 140 °C as measured in accordance with JIS Z 1707 at a tensile rate of 300 mm/minute can be formed. The heating method is not particularly limited, but, for example, can be performed by using a heat seal apparatus using a heated plate, impulses, high frequencies, ultrasonic waves, etc.

### {Crystalline Polyethylene Terephthalate-Based Resin}

The crystalline polyethylene terephthalate-based resin contained in the heat seal layer-forming resin composition is obtained by reacting a polycarboxylic acid component containing a terephthalic acid component and a polyhydric alcohol containing an ethylene glycol component, and is not particularly limited as long as an ethylene terephthalate unit is contained and crystallinity is exhibited. The crystalline polyethylene terephthalate-based resin of the present invention contains 60 mass % or more, preferably 80 mass % or more, and more preferably 85 mass % or more of the ethylene terephthalate unit per 100 mass % of all constituting units. Here, the upper limit of the ethylene terephthalate unit is 100 mass % (homopolymer).

The crystalline polyethylene terephthalate-based resin may be a homopolymer or a copolymer. A copolymer is obtained by substituting a part of the polycarboxylic acid component and/or polyhydric alcohol component with a copolymerization component and then performing the reaction.

Of the copolymerization component, a polycarboxylic acid copolymerization component that can be contained in the polycarboxylic acid component is, for example, at least one selected from the group consisting of aromatic polycarboxylic acids such as isophthalic acid, phthalic acid, methyl terephthalic acid, methyl isophthalic acid, naphthalenedicarboxylic acid (2,6-naphthalenedicarboxylic acid, 2,7-naphthalenedicarboxylic acid, 1,5-naphthalenedicarboxylic acid, etc.), 4,4′-diphenyldicarboxylic acid, 3,4′-diphenyldicarboxylic acid, 4,4′-diphenoxyethanedicarboxylic acid, diphenyl ether dicarboxylic acid, diphenylmethane dicarboxylic acid, diphenylethane dicarboxylic acid, and diphenyl ketone dicarboxylic acid; alicyclic polycarboxylic acids such as cyclohexanedicarboxylic acid, hexahydrophthalic acid, hexahydroisophthalic acid, hexahydroterephthalic acid, himic acid, and norbornanedicarboxylic acid; aliphatic dicarboxylic acids such as succinic acid, adipic acid, pimelic acid, suberic acid, azelaic acid, sebacic acid, decanedicarboxylic acid, dodecanedicarboxylic acid, hexadecanedicarboxylic acid, and dimer acid; polycarboxylic acids such as trimellitic acid, trimesic acid, and pyromellitic acid; and reactive derivatives such as C1-C6 alkyl esters, acid halides, and acid anhydrides of these polycarboxylic acid copolymerization components; etc. At least one selected from the group consisting of isophthalic acid, sebacic acid, adipic acid, and reactive derivatives thereof (C1-C6 alkyl esters, acid halides, and acid anhydrides) is preferable.

The amount of these polycarboxylic acid copolymerization components used is 30 mol % or less, preferably 25 mol % or less, and more preferably 20 mol % or less of all polycarboxylic acid components.

Of the copolymerization components described above, a polyhydric alcohol copolymerization component that can be contained in the polyhydric alcohol component is, for example, at least one selected from the group consisting of aliphatic diols such as trimethylene glycol, propylene glycol, 1,3-butanediol, tetramethylene glycol, neopentyl glycol, hexamethylene glycol, octanediol, and decanediol; polyoxyalkylene glycols such as diethylene glycol, triethylene glycol, polyoxyethylene glycol, ditetramethylene glycol, polytetramethylene ether glycol, dipropylene glycol, tripropylene glycol, polyoxypropylene glycol, and polytetramethylene ether glycol; alicyclic diols such as cyclohexanediol and 1,4-cyclohexanedimethanol; aromatic diols such as hydroquinone, resorcinol, naphthalenediol, dihydroxydiphenyl ether, and C2-C4 alkylene oxide adducts of bisphenols; polyhydric alcohols such as glycerin, trimethylolpropane, and pentaerythritol; etc. At least one selected from the group consisting of propylene glycol, 1,4-butanediol, diethylene glycol, and 1,4-cyclohexanedimethanol is preferable.

The amount of these polyhydric alcohol copolymerization components used is 30 mol % or less, preferably 25 mol % or less, and more preferably 20 mol % or less of all polyhydric alcohol components.

In addition, as the copolymerization component, at least one selected from the group consisting of hydroxycarboxylic acid components such as 2-hydroxypropanoic acid, 3-hydroxypropanoic acid, hydroxybutanoic acid, ε-oxocaproic acid, hydroxybenzoic acid, hydroxyethoxybenzoic acid, oxynaphthoic acid, diphenyleneoxycarboxylic acid, and reactive derivatives thereof; cyclic ester components such as propiolactone, butyrolactone, valerolactone, and ε-caprolactone; etc., can be used. The amount of the constituting units from these hydroxycarboxylic acid components or cyclic ester components used can be set to 20 mol % or less and preferably 10 mol % or less of all constituting units of the polyethylene terephthalate-based resin.

The number-average molecular weight of the polyethylene terephthalate-based resin is not particularly limited. For example, it is 0.5×10⁴ or more, preferably 1.0×10⁴ or more, and more preferably 1.2×10⁴ or more, and, for example, it is 1.0×10⁶ or less, preferably 7.0×10⁵ or less, and more preferably 3.0×10⁵ or less.

A commercially available product or a product obtained by a known polymerization method may be used as the polyethylene terephthalate-based resin. Furthermore, regenerated resins obtained by crushing or melt-pelletizing used resins, such as used polyethylene terephthalate bottles (PET bottles) may be used as the polyethylene terephthalate-based resin.

A crystalline polyethylene terephthalate-based resin is a crystalline resin that has a crystal fusion peak temperature in the range of 220 °C or more and 270 °C or less in thermal analysis by differential scanning calorimetry (DSC) and that has a crystal heat of fusion (ΔHₘ) of 10 J/g or more detected at the crystal peak temperature observed when the temperature is increased to a temperature equal to or higher than the crystal fusion peak temperature at 10 °C/minute, then decreased to room temperature at the same rate, and again increased at the same rate.

The crystal fusion peak temperature is in the range of preferably 220 °C or more and more preferably 245 °C or more and is preferably 270 °C or less and more preferably 265 °C or less.

The crystal heat of fusion (ΔHₘ) is preferably 25 J/g or more and more preferably 50 J/g or more.

The crystalline polyethylene terephthalate-based resin has a intrinsic viscosity of 0.60 dl/g or more, preferably 0.65 dl/g or more, more preferably 0.75 dl/g or more and 0.90 dl/g or less, and preferably 0.85 dl/g or less when dissolved in a phenol:tetrachloroethane=1:1 mixed solvent and measured with a Ubbelohde viscometer at 25 °C. When the intrinsic viscosity is less than 0.60 dl/g, the melt viscosity may become insufficient during film formation, and the film formation may become instable. When the intrinsic viscosity exceeds 0.90 dl/g, it may become difficult to exhibit heat seal properties.

The method for producing the crystalline polyethylene terephthalate-based resin is not particularly limited. For example, the following (a), (b), etc., may be employed for the production;
(a) a method that involves polymerizing the polycarboxylic acid component and the polyhydric alcohol component under heating in the presence or absence of a polycondensation catalyst containing titanium, germanium, antimony, etc., and discharging by-product water, lower alcohols, etc., out of the system,
(b) a method that involves preparing a low-polymerization-degree polymer, for example, by direct esterification by a reaction between a polycarboxylic acid component and a polyhydric alcohol component in the presence or absence of a catalyst or by transesterification between a dialkyl ester of a polycarboxylic acid component and a polyhydric alcohol component in the presence of a catalyst, and then holding this low-polymerization-degree polymer and a catalyst at an appropriate temperature (for example, about 240 to 310 °C) at a reduced pressure (for example, at a vacuum of 11.7 Pa or less) to perform condensation polymerization by melt polycondensation or solid-phase polycondensation.

The method for producing the polyethylene terephthalate-based resin may be a batch polymerization method or a continuous polymerization method.

The polycondensation catalyst used in the method for making the crystalline polyethylene terephthalate-based resin is not particularly limited. For example, a polycondensation catalyst containing titanium and/or germanium is preferably used, and a polycondensation catalyst containing germanium is particularly preferably used. The amount of the polycondensation catalyst used relative to the polyethylene terephthalate-based resin is, for example, 0.004 mass % or more and preferably 0.02 mass % or more and, for example, 0.09 mass % or less and preferably 0.06 mass % or less.

A germanium-based polycondensation catalyst is preferably used as the polycondensation catalyst since, when a heat-resistant container for food is formed, the food safety and hygiene risks associated with migration of leaching substances into food can be reduced.

The germanium-based polycondensation catalyst is, for example, at least one selected from the group consisting of oxides, hydroxides, halides, alcoholates, phenolates, etc., of germanium. A specific example is at least one selected from the group consisting of germanium oxide, germanium hydroxide, germanium tetrachloride, tetramethoxygermanium, etc.

In the present invention, compounds of manganese, zinc, calcium, magnesium, etc., that are used in the transesterification reaction preceding the polycondensation can be used in combination. In addition, after completion of the transesterification reaction, a phosphoric acid or phosphorus acid-based compound may be added to deactivate the polycondensation catalyst and terminate the reaction.

The content of the polyethylene terephthalate-based resin in the heat seal layer-forming resin composition is, for example, 70 mass % or more, preferably 80 mass % or more, and more preferably 90 mass % or more relative to 100 mass % of the entire heat seal layer-forming resin composition. In such a range, the film forming properties, heat resistance, chemical resistance, and oil resistance of the heat seal layer-forming resin composition can be improved.

### {Epoxy Group-Containing Styrene-(Meth)Acrylic Acid Ester-Based Resin}

The epoxy group-containing styrene-(meth)acrylic acid ester-based resin contained in the heat seal layer-forming resin composition is a resin that contains, as constituting units, a styrene unit, a (meth)acrylic acid ester unit, and an epoxy group-containing monomer unit. In the present invention, a styrene-(meth)acrylic acid ester-based resin that has one or more types of epoxy groups can be used.

A styrene unit is a unit obtained by polymerizing styrene. The styrene unit accounts for, for example, 5 mass % or more and preferably 10 mass % or more and, for example, 95 mass % or less and preferably 90 mass % or less of 100 mass % of all constituting units of the epoxy group-containing styrene-(meth)acrylic acid ester-based resin.

The (meth)acrylic acid ester unit is a unit obtained by polymerizing a (meth)acrylic acid ester.

The (meth)acrylic acid ester is, for example, at least one selected from the group consisting of alkyl group-containing (meth)acrylic acid esters such as methyl (meth)acrylate, ethyl (meth)acrylate, propyl (meth)acrylate, butyl (meth)acrylate, isobutyl (meth)acrylate, pentyl (meth)acrylate, hexyl (meth)acrylate, heptyl (meth)acrylate, 2-ethylhexyl (meth)acrylate, octyl (meth)acrylate, nonyl (meth)acrylate, and stearyl (meth)acrylate; alicyclic group-containing (meth)acrylic acid esters such as isobornyl (meth)acrylate and cyclohexyl (meth)acrylate; aromatic group-containing (meth)acrylic acid esters such as phenyl (meth)acrylate, phenoxyethyl (meth)acrylate, benzyl (meth)acrylate, and biphenyl (meth)acrylate; alkoxy group-containing (meth)acrylic acid esters such as 2-methoxyethyl acrylate, 2-ethoxyethyl acrylate, methoxypolyethylene glycol (meth)acrylate, methoxypolypropylene glycol (meth)acrylate, and ethoxypolypropylene glycol (meth)acrylate; hydroxy group-containing (meth)acrylic acid esters such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate; amino group-containing (meth)acrylic acid esters such as monoalkylaminoester (meth)acrylates such as monomethylaminoethyl (meth)acrylate, monoethylaminoethyl (meth)acrylate, monomethylaminopropyl (meth)acrylate, and monoethylaminopropyl (meth)acrylate; heterocyclic group-containing (meth)acrylic acid esters such as (meth)acryloylmorpholine; isocyanate group-containing (meth)acrylic acid esters such as 2-isocyanatoethyl (meth)acrylate; etc. At least one selected from the group consisting of alkyl group-containing (meth)acrylic acid esters and alicyclic group-containing (meth)acrylic acid esters is preferable, and methyl (meth)acrylate is more preferable.

The (meth)acrylic acid ester unit accounts for, for example, 5 mass % or more and preferably 10 mass % or more and, for example, 95 mass % or less and preferably 90 mass % or less of 100 mass % of all constituting units of the epoxy group-containing styrene-(meth)acrylic acid ester-based resin.

A specific example of an epoxy group-containing monomer is at least one selected from the group consisting of glycidyl (meth)acrylate, (3,4-epoxycyclohexyl)methyl (meth)acrylate, (6-methyl-3,4-epoxycyclohexyl)methyl (meth)acrylate, allyl glycidyl ether, vinyl glycidyl ether, etc. At least one selected from the group consisting of glycidyl (meth)acrylate and (3,4-epoxycyclohexyl)methyl (meth)acrylate is preferable.

The epoxy group-containing monomer accounts for, for example, 20 mass % or more and preferably 30 mass % or more and, for example, 60 mass % or less and preferably 50 mass % or less of 100 mass % of all constituting units of the epoxy group-containing styrene-(meth)acrylic acid ester-based resin.

Furthermore, the amount can be that the epoxy value of the epoxy group-containing styrene-(meth)acrylic acid ester-based resin measured in accordance with ASTM D1652 is 0.5 meq/g or more and preferably 1.0 meq/g or more and 3.0 meq/g or less and preferably 2.5 meq/g or less. When the epoxy value of the epoxy group-containing styrene-(meth)acrylic acid ester-based resin is less than 0.5 meq/g, sufficient melt viscosity may not be maintained during production of the heat seal layer, and sufficient heat seal properties may not be exhibited due to an increased crystallinity of the heat seal layer; in addition, when the epoxy value exceeds 2.5 meq/g, re-polymerization between the polyethylene terephthalate-based resin molecules becomes excessive, and gel foreign substances may occur during the production of the heat seal layer.

The epoxy group-containing styrene-(meth)acrylic acid ester-based resin may contain a constituting unit constituted by “an additional monomer” other than styrene, the (meth)acrylic acid ester, and the epoxy group-containing monomer.

The additional monomer is not particularly limited, and can be selected, as appropriate, from monomers having polymerizable carbon-carbon-unsaturated bond and capable of copolymerizing with styrene, the (meth)acrylic acid ester, and an epoxy group-containing monomer. Examples thereof include vinyl esters such as vinyl acetate and vinyl propionate, unsaturated nitriles such as (meth)acrylonitrile, and hydroxy(meth)acrylamides such as (meth)acrylamide, N-vinylpyrrolidone, hydroxymethylacrylamide, and hydroxyethylacrylamide.

The additional monomer accounts for, for example, 50 mass % or less and preferably 30 mass % or less of 100 mass % of all constituting units of the epoxy group-containing styrene-(meth)acrylic acid ester-based resin.

The weight-average molecular weight of the epoxy group-containing styrene-(meth)acrylic acid ester-based resin is not particularly limited. It is, for example, 2000 or more and preferably 3000 or more and, for example, 25000 or less and preferably 10000 or less. In addition, the polydispersity of the epoxy group-containing styrene-(meth)acrylic acid ester-based resin is not particularly limited. It is, for example, 1.1 or more and preferably 1.2 or more and, for example, 5.5 or less and preferably 5.0 or less.

A commercially available product or a product of polymerization of particular monomers may be used as the epoxy group-containing styrene-(meth)acrylic acid ester-based resin.

For example, “JONCRYL ADR” series produced by BASF Japan Ltd. (ADR 4368 etc.), “ARUFON UG-4000” series produced by TOAGOSEI CO., LTD. (UG-4035, UG-4040, UG-4070, etc.), etc. can be used as the commercially available product.

In order to produce the resin by polymerizing particular monomers, for example, a high-temperature continuous polymerization method disclosed in Japanese Unexamined Patent Application Publication No. 59-6207, Japanese Unexamined Patent Application Publication No. 60-215007, etc., can be employed. An example thereof is a method that involves continuously feeding a mixture of particular monomers at a constant feeding rate to a reactor set at a particular temperature and a particular pressure and discharging the reaction liquid in an amount proportional to the feed amount.

The content of the epoxy group-containing styrene-(meth)acrylic acid ester-based resin in the heat seal layer-forming resin composition relative to 100 parts by mass of the crystalline polyethylene terephthalate-based resin is 0.1 parts by mass or more and 0.9 parts by mass or less. Preferably, it is 0.1 parts by mass or more and 0.6 parts by mass or less and more preferably 0.1 parts by mass or more and 0.5 parts by mass or less. When the content of the epoxy group-containing styrene-(meth)acrylic acid ester-based resin exceeds 0.9 parts by mass, the heat seal layer-forming resin composition may undergo gelation, and when the content is less than 0.1 parts by mass, the heat seal properties, and film forming properties such as neck-in and draw-down may be degraded.

### {Polybutylene Terephthalate-Based Resin}

The polybutylene terephthalate-based resin that may be contained in the heat seal layer-forming resin composition is a resin that contains a structural unit derived from terephthalic acid and a structural unit derived from 1,4-butanediol component.

Since the polybutylene terephthalate-based resin has lower hydrolyzability than the polyethylene terephthalate-based resin, during the processes of producing a heat seal layer-forming resin composition and a container-forming material containing the heat seal layer-forming resin composition, a preliminary drying process or the like can be easily carried out.

A commercially available product or a product obtained by a known polymerization method of reacting a polycarboxylic acid component containing a terephthalic acid component and a polyhydric alcohol component containing a 1,4-butanediol component may be used as the polybutylene terephthalate-based resin.

The polycarboxylic acid component contains 60 mol % or more and 100 mol % or less of at least one terephthalic acid component selected from terephthalic acid, halides of terephthalic acid (for example, terephthaloyl dichloride), and diesters of terephthalic acid (for example, dimethyl terephthalate). The polycarboxylic acid component other than the terephthalic acid component is not particularly limited. An example is at least one selected from the group consisting of isophthalic acid, orthophthalic acid, adipic acid, 2-chloroterephthalic acid, 2,5-dichloroterephthalic acid, 2-methylterephthalic acid, 4,4-stilbenedicarboxylic acid, 4,4-biphenyldicarboxylic acid, 2,6-naphthalenedicarboxylic acid, 2,7-naphthalenedicarboxylic acid, bisbenzoic acid, bis(p-carboxyphenyl)methane, anthracenedicarboxylic acid, 4,4-diphenyl ether dicarboxylic acid, 4,4-diphenoxyethane dicarboxylic acid, 4,4-diphenyl ketone dicarboxylic acid, 4,4-diphenyl ether dicarboxylic acid, 5-Na sulfoisophthalic acid, ethylene-bis-p-benzoic acid, acid halides thereof, diesters thereof, anhydrides thereof, etc.

The polyhydric alcohol component contains 70 mol % or more and 100 mol % or less of 1,4-butanediol. The polyhydric alcohol component other than 1,4-butanediol is not particularly limited. An example is at least one selected from the group consisting of ethylene glycol, diethylene glycol, 1,2-propylene glycol, 1,3-propanediol, 2,2-dimethyl-1,3-propanediol, trans- or cis-2,2,4,4-tetramethyl-1,3-cyclobutanediol, neopentyl glycol, 1,5-pentanediol, 1,6-hexanediol, 1,4-cyclohexanedimethanol, 1,3-cyclohexanedimethanol, decamethylene glycol, cyclohexanediol, p-xylenediol, bisphenol A, tetrabromobisphenol A, tetrabromobisphenol A-bis(2-hydroxyethyl ether), etc.

The method for making the polybutylene terephthalate-based resin is not particularly limited. For example, the polycarboxylic acid component and the polyhydric alcohol component are polymerized under heating in the presence of a polycondensation catalyst containing titanium, germanium, antimony, etc., and by-product water, lower alcohols, etc., are discharged out of the system. In the present invention, a polycondensation catalyst containing titanium and/or germanium is preferably used, and a polycondensation catalyst containing germanium is particularly preferably used.

The germanium-based polycondensation catalyst is, for example, at least one selected from the group consisting of oxides, hydroxides, halides, alcoholates, phenolates, etc., of germanium. A specific example is at least one selected from the group consisting of germanium oxide, germanium hydroxide, germanium tetrachloride, tetramethoxygermanium, etc.

In the present invention, compounds of manganese, zinc, calcium, magnesium, etc., that are used in the transesterification reaction preceding the polycondensation can be used in combination. In addition, after completion of the transesterification reaction, a phosphoric acid or phosphorus acid-based compound may be added to deactivate the polycondensation catalyst and terminate the reaction.

The method for producing the polybutylene terephthalate-based resin may be a batch polymerization method or a continuous polymerization method.

The content of the polybutylene terephthalate-based resin in the heat seal layer-forming resin composition relative to 100 parts by mass of the crystalline polyethylene terephthalate-based resin is 0 parts by mass or more and less than 30 parts by mass. The heat seal layer-forming resin composition does not have to contain the polybutylene terephthalate-based resin. When a polybutylene terephthalate-based resin is contained in the heat seal layer-forming resin composition, the content is preferably 0.1 parts by mass or more and 29.9 parts by mass or less relative to 100 parts by mass of the crystalline polyethylene terephthalate-based resin. When a polybutylene terephthalate-based resin is contained in the heat seal layer-forming resin composition, drawability in forming a heat-resistant container by using a container-forming material having a heat seal layer containing a heat seal layer-forming resin composition and a substrate layer is improved, and when the container-forming material is heat-sealed, the pinhole resistance of suppressing generation of pinholes and weather resistance can be improved.

When the content of the polybutylene terephthalate-based resin relative to 100 parts by mass of the crystalline polyethylene terephthalate-based resin is 30 parts by mass or more, the heat seal properties of the polyethylene terephthalate-based resin may be degraded, and a heat seal layer formed as a result may have degraded heat seal properties.

### {Other Components}

The heat seal layer-forming resin composition may contain, in addition to the polyethylene terephthalate-based resin, the epoxy group-containing styrene-(meth)acrylic acid ester-based resin, and the polybutylene terephthalate-based resin, other components as long as the performance necessary for the heat seal layer-forming resin composition is not impaired.

Examples of the other components include at least one selected from the group consisting of a resin, an antioxidant, a heat stabilizer, a UV absorber, a light stabilizer, a lubricant, a plasticizer, a release agent, a flame retardant, a flame retardant assistant, an antistatic agent, an anti-fogging agent, a reinforcing material, a colorant, a color prevention agent, a neutralizing agent, a nucleating agent, a film-forming aid, a processing aid, a filler, etc.

### <Structure of the Container-Forming Material>

The container-forming material contains the aforementioned heat seal layer-forming resin composition and has a film or sheet form. The container-forming material may be, for example, formed of a film or sheet containing the heat seal layer-forming resin composition. Alternatively, the container-forming material may be formed of a laminate that includes a heat seal layer containing the heat seal layer-forming resin composition and other layers such as a substrate layer. In the present invention, the container-forming material is preferably formed from a laminate that includes a heat seal layer and other layers such as a substrate layer.

### (Container-Forming Material Based on Film or Sheet Containing Heat Seal Layer-Forming Resin Composition)

A container-forming material based on a film or sheet containing a heat seal layer-forming resin composition can be, for example, obtained by forming a film from the heat seal layer-forming resin composition by means of a casting method, an inflation molding method, or the like.

In a container-forming material based on a film or sheet containing a heat seal layer-forming resin composition, the film or sheet containing the heat seal layer-forming resin composition is preferably obtained by a casting method from the viewpoints of thickness uniformity, transparency, productivity, etc. The temperature of the heat seal layer-forming resin composition during film formation is not particularly limited. It is, for example, 220 °C or more and preferably 230 °C or more and, for example, 300 °C or less and preferably 290 °C or less. From the viewpoint of obtaining a film or sheet having high surface smoothness and specular gloss, a film forming method that includes a step of extruding a material containing the heat seal layer-forming resin composition through a T die into a film or sheet and causing at least one side of the extruded film or sheet to contact a mirror surface of a mirror roll, a mirror belt, or the like is preferred.

In the present invention, from the viewpoint of removing foreign substances in the container-forming material based on a film or sheet containing a heat seal layer-forming resin composition, an extruder equipped with a vacuum vent mechanism that can remove impurities during molding is preferably used, and more preferably an extruder equipped with a sintered metal filter at the tip is used for production.

The thickness of the container-forming material based on the film or sheet containing the heat seal layer-forming resin composition is not particularly limited. For example, it is 5 μm or more, preferably 10 μm or more, and more preferably 20 μm or more and, for example, 500 μm or less, preferably 300 μm or less, and more preferably 200 μm or less. When the thickness of the container-forming material is less than 10 μm, stable production may become difficult. A thickness exceeding 500 μm is disadvantageous since secondary workability such as bendability, cuttability, and punchability may be degraded and the cost for material increases.

The container-forming material based on a film or sheet containing the heat seal layer-forming resin composition may be colorless and transparent, colored and transparent, or colored and opaque. Furthermore, at least one type of pattern selected from the group consisting of a pictorial pattern, a character, a diagram, etc., may be formed on at least one surface of the container-forming material based on the film or sheet containing the heat seal layer-forming resin composition.

An example of the coloring method is at least one selected from the group consisting of a method that involves adding a colorant to a raw material resin or a resin composition before molding, a method that involves immersing a produced film in a dye-containing liquid, etc. The pattern may be chromatic or achromatic. The method for forming the pattern is not particularly limited, and examples thereof include printing, drawing by an operator, transferring, etc.

### (Container-Forming Material Based on Laminate Having Heat Seal Layer and Substrate Layer)

In the container-forming material based on a laminate having a heat seal layer and a substrate layer, the heat seal layer contains the heat seal layer-forming resin composition. The thickness of the heat seal layer is not particularly limited. For example, it is 10 μm or more, preferably 20 μm or more, and more preferably 30 μm or more and, for example, 120 μm or less, preferably 100 μm or less, and more preferably 90 μm or less. When the thickness of the heat seal layer is less than 10 μm, the heat seal strength may decrease, and the impact resistance of the formed heat-resistant container may be degraded. When the thickness of the heat seal layer exceeds 120 μm, there is a disadvantage from the aspect of the cost, the balance between flexibility and rigidity may no longer be achieved, and the bending resistance may be degraded.

In the container-forming material based on a laminate having a heat seal layer and a substrate layer, the heat seal layer is a layer that directly contacts food and the like when a heat-resistant container is constituted by the container-forming material and is a layer that constitutes a so-called inner surface when the heat-resistant container is sealed.

In the container-forming material based on a laminate having a heat seal layer and a substrate layer, the substrate layer retains the heat seal layer and is not particularly limited as long as the substrate layer has properties that enable a heat-resistant container formed by the container-forming material to function as a heat-resistant container. The substrate layer is, for example, at least one layer selected from the group consisting of a resin layer, a paper layer, and a metal layer, or at least one layer containing at least one of a resin, paper, a metal, etc. A resin layer subjected to a stretching process may be employed as the resin layer as necessary.

An example of the resin that forms the resin layer is at least one selected from the group consisting of at least one thermoplastic resin selected from the group consisting of polyester-based resins, polycarbonate-based resins, polyamide-based resins, polyolefin-based resins, styrene-based resins, vinyl halide-based resins, (meth)acrylic resins, ABS (acrylonitrile-butadiene-styrene copolymer)-based resins, polyurethane-based resins, etc.; at least one thermosetting resin selected from the group consisting of epoxy-based resins, urethane-based resins, phenolic resins, melamine-based resins, etc.; mixtures of these resins; etc. Among these, polyester-based resins are preferably used. In such a case, the resin layer preferably includes a biaxially stretched polyester-based resin film layer.

When the resin layer forming the substrate layer is formed by a polyester-based resin, an aromatic polyester-based resin film is preferably used. The aromatic polyester-based resin film is not particularly limited, and various types can be used irrespective of the type of the polyester-based resin or whether the film is stretched or not. In particular, it is advantageous to use a biaxially stretched aromatic polyester-based resin film since a substrate layer that has strong tensile strength, rigidity, and excellent printing suitability can be formed.

Examples of the biaxially stretched aromatic polyester-based resin film include a film that includes at least one layer of a biaxially stretched polyethylene terephthalate-based resin film, a biaxially stretched polybutylene terephthalate-based resin film, and a biaxially stretched polyethylene naphthalate-based resin film. Of these, a biaxially stretched polyethylene terephthalate-based resin film layer is preferable since it is inexpensive and those with various properties can be easily procured. A biaxially stretched polybutylene terephthalate-based resin film layer is preferable for its excellent pinhole resistance. A biaxially stretched polyethylene naphthalate-based resin film layer has a high crystal fusion peak temperature, excellent heat resistance, and excellent dead hold properties, and is also advantageous in imparting the self-supportability to a cooking bag (during or after cooking).

When the resin layer includes a biaxially stretched polyester-based resin film or a biaxially stretched polyamide-based resin film, an inorganic layer containing a metal and/or a metal oxide as a main component may be provided on at least one surface of the film. Examples of the method for forming a film of the inorganic layer include a vacuum deposition method, an ion plating method, a sputtering method, a CVD (chemical vapor deposition) method, etc.

The thickness of the inorganic layer on the biaxially stretched polyester-based resin film is not particularly limited, and is, for example, 1 nm or more and preferably 5 nm or more and, for example, 300 nm or less and preferably 100 nm or less.

At least one selected from the group consisting of aluminum, silicon, magnesium, tin, silver, gold, stainless steel, titanium, etc., is an example of the metal constituting the inorganic layer. At least one selected from the group consisting of aluminum oxide, calcium oxide, silver oxide, gold oxide, silicon oxide, tin oxide, titanium oxide, iron oxide, magnesium oxide etc., is an example of the metal oxide constituting the inorganic layer.

Of these, a biaxially stretched aromatic polyester-based resin film on which an aluminum vapor deposited film is formed is industrially available at a low price, and it becomes possible to use an IH cooking device or the like as the means for heating a heat-resistant container constituted by the container-forming material based on a laminate having a heat seal layer and a substrate layer. Furthermore, it becomes possible to impart gas barrier properties to a container-forming material based on a laminate having a heat seal layer and a substrate layer and to a heat-resistant container constituted by the container-forming material. In addition, a biaxially stretched aromatic polyester-based resin film on which silica or alumina is vapor-deposited can impart gas barrier properties to a container-forming material based on a laminate having a heat seal layer and a substrate layer and to a heat-resistant container constituted by the container-forming material.

Paper that constitutes the paper layer is not particularly limited as long as it is used in package applications irrespective of the type and grammage. For example, bleached kraft paper, high quality paper, etc., can be used, and a cooking bag that uses bleached kraft paper or high quality paper is preferably used since the cooking bag can be produced by a typical bag-making machine and, when the cooking bag is placed on a pot on direct fire, the cooking bag does not melt, remains unperforated, does not catch fire, and thus can appropriately cook food through appropriate heat conduction.

The metal constituting the metal layer is not particularly limited, and metal and the like used in cookware can be used. An example thereof is at least one selected from the group consisting of aluminum, magnesium, silver, gold, iron, stainless steel, titanium, etc. When the substrate layer is constituted by a metal layer or includes a metal layer, it becomes possible to use an IH cooking device or the like as the means for heating a heat-resistant container constituted by a container-forming material based on a laminate having a heat seal layer and a substrate layer.

When an aluminum foil is used as the metal layer, due to high thermal conductivity, the food heating efficiency is improved, and it becomes possible to impart light shielding properties and gas barrier properties to a container-forming material based on a laminate having a heat seal layer and a substrate layer and to a heat-resistant container constituted by the container-forming material. Any aluminum foil that serves package applications can be applied irrespective of the type and thickness. For example, alloy foils such as N8021 material and N8079 material and common foils such as 1N30 material can be used.

When the container-forming material is a laminate having the heat seal layer and the substrate layer, the substrate layer preferably includes at least one layer selected from the group consisting of a biaxially stretched polyester-based resin layer, a paper layer, a metal vapor-deposited biaxially stretched polyester-based resin layer, and a metal foil layer.

In the container-forming material based on a laminate having a heat seal layer and a substrate layer, the substrate layer is a layer that constitutes the outer surface of a heat-resistant container constituted by the container-forming material, and comes into direct contact with a heated pot or frying pan, hot water, hot air, or the like during heating of the heat-resistant container. Thus, the substrate layer is preferably a heat resistant layer and, for example, is preferably constituted by at least one layer selected from the group consisting of a biaxially stretched aromatic polyester-based resin layer, a vapor-deposited biaxially stretched aromatic polyester-based resin layer, a paper layer, and a metal foil layer (aluminum foil, stainless steel foil, or the like).

In the container-forming material based on a laminate having a heat seal layer and a substrate layer, the thickness when the substrate layer is a resin layer or a metal layer is not particularly limited. For example, it is 5 μm or more, preferably 8 μm or more, and more preferably 10 μm or more and, for example, 3000 μm or less, preferably 1500 μm or less, more preferably 1000 μm or less, yet more preferably 500 μm or less, and still more preferably 300 μm or less. When the thickness of the substrate layer is in the range of 5 μm or more and 3000 μm or less and when a heat-resistant container is formed, the rigidity and impact resistance of the container can be at a practical level. Furthermore, when heat seal layers are stacked, a laminate that strikes a balance between flexibility and rigidity can be made.

In the container-forming material based on a laminate having a heat seal layer and a substrate layer, the grammage when the substrate layer is a paper layer is not particularly limited. For example, the grammage in accordance with JIS P 8124 is, for example, 10 g/m² or more, preferably 14 g/m² or more, and more preferably 40 g/m² or more, and, for example, 300 g/m² or less, preferably 25 Og/m² or less, and more preferably 200 g/m² or less.

In the present invention, at least one selected from the group consisting of an anchor coat layer, a coloring layer, a printed pattern layer, a gas barrier layer, a light shielding layer, an antireflection layer, an antiglare layer, an antistatic layer, an antifouling layer, etc., can be formed on a surface of the substrate layer as necessary. In this manner, a container-forming material and a heat-resistant container (for example, a cooking bag, a cooking dish, or the like) that are excellent in design properties, gas barrier properties, light-shielding properties, pinhole resistance, curling resistance, etc., can be obtained. In addition, for example, it is possible to laminate an aluminum foil layer for imparting light-shielding properties and the like between the substrate layer and the heat seal layer.

In the present invention, for the purpose of imparting easy-openability when a heat-resistant container such as a heat-resistant bag is formed, the substrate layer can be subjected to a surface roughening process, a notching process, or the like. Similarly, the container-forming material itself may be subjected to a surface roughening process, a notching process, or the like for the purpose of imparting easy-openability when a heat-resistant container is formed.

The method for producing a container-forming material based on a laminate having a heat seal layer and a substrate layer is not particularly limited. For example, a heat seal layer and a substrate layer may be directly joined together, or may be joined together with an adhesive layer or an anchor coat layer therebetween.

Examples of the method for producing a container-forming material based on a laminate having a heat seal layer and a substrate layer include, for example, following (1) to (4);
(1) after a film or sheet that contains the heat seal layer-forming resin composition and a material that forms a substrate layer are separately prepared and an easy adhesion process is performed on an adhesive surface of at least one of these, performing a continuous lamination method by passing these between a pair of heating rolls or non-heating rolls as necessary, a press thermal bonding method, or a method that simultaneously perform compression air or vacuum molding and stacking;
(2) after a film or sheet that contains the heat seal layer-forming resin composition and a material that forms a substrate layer are separately prepared and an adhesive is applied to at least one of these, performing a continuous lamination method by passing these between a pair of heating rolls or non-heating rolls as necessary, a press (thermal) bonding method, or a method that simultaneously perform compression air or vacuum molding and stacking;
(3) an extrusion lamination method that involves laminating the heat seal layer-forming resin composition melt-extruded from a T die onto a substrate layer; and
(4) a co-extrusion method that involves co-extruding the heat seal layer-forming resin composition and a resin material that forms a substrate layer to produce a multilayer film.

When the substrate layer is a resin layer, by forming a heat seal layer by the co-extrusion method or extrusion lamination method and making a container-forming material based on a laminate having a heat seal layer and a substrate layer, leaching of low-molecular-weight components derived from an adhesive and the like can be suppressed even when the heat-resistant container constituted by the container-forming material is overheated.

When the substrate layer is a paper layer, a method of directly laminating a melted heat seal layer-forming resin composition onto a paper layer by using an extrusion lamination molding machine is simple and preferable since leaching of low-molecular-weight components and the like can be further suppressed. Note that, if necessary, the paper layer can be coated with an anchor coat agent in advance; however, the anchor coat agent is preferably not used since leaching of the low-molecular-weight components and the like can be further reduced.

When the extrusion lamination method is used in the method for producing a container-forming material based on a laminate having a heat seal layer and a substrate layer, the heat seal properties can be improved by decreasing the temperature of the cooling rolls to rapidly cool the heat seal layer-forming resin composition and to suppress the crystallinity thereof to a low level. In this manner, the heat seal properties can be exhibited at low temperature, and the heat seal strength can be improved when heat sealing is performed under the same temperature condition. For example, when the chill roll (cooling roll) in extrusion lamination is set to 40 °C or less and the chill roll itself is controlled to avoid dew condensation, the crystallinity of the heat seal layer can be suppressed to 15% or less.

The adhesive used in producing the container-forming material based on a laminate having a heat seal layer and a substrate layer is not particularly limited, and at least one of a solventless adhesive, an aqueous adhesive, a solvent-based adhesive, a hot-melt adhesive, a two-component-type curable adhesive, an active energy ray-curable adhesive, etc., can be used.

Among these, a two-component-type curable adhesive, an active energy ray-curable adhesive, a solventless adhesive, etc., are preferably used. In addition, the hot-melt adhesive is preferably a material having a sufficiently high melting point.

### <Form and Production Method of Heat-Resistant Container>

The form, etc., of the heat-resistant container are not particularly limited. By utilizing the flexibility of the container-forming material and heat-sealing the aligned heat seal layers of one or more container-forming materials with desired size and shape, a heat-resistant bag, which is a bag-shaped heat-resistant container, can be made, for example. Examples of the heat-resistant bag include typical three-side-sealed bags, pillow bags, gusseted bags, and bottomed stand-up bags. The heat-resistant bag can be processed so as to be sealable after the content is placed.

Furthermore, a rigid container that utilizes the rigidity brought about by the thickness of the container-forming material and the combination of raw materials can be formed. In such a case, the content does not have to be sealed and an open container resembling a dish can be formed.

The heat-resistant bag which is a bag-shaped heat-resistant container may be equipped with a zipper that allows opening and closing by a simple means. The material for the zipper is preferably a material that can be fusion-bonded with the heat seal layer, and can be, for example, a polyester-based resin contained in the heat seal layer-forming resin composition or the like.

Furthermore, for the purpose of imparting easy-openability when a heat-resistant bag is sealed, a surface roughening process, a notching process, or the like can be performed. Furthermore, a notch or the like for forming a gas releasing part after sealing can be provided to the heat-resistant bag.

FIG. 1 includes schematic diagrams illustrating a first heat-resistant bag according to one embodiment of the heat-resistant container of the present invention and formation of the first heat-resistant bag by heat sealing. In FIG. 1(1A), 101 denotes a first heat-resistant bag front member, 102 denotes a first heat-resistant bag rear member, and 103 denotes a first heat-resistant bag bottom member; in FIG. 1(1B), 110 denotes a first heat-resistant bag heat seal portion and 120 denotes a first heat-resistant bag preform; in FIG. 1(1C), 130 denotes an unneeded portion cut away as unneeded part and 121 denotes the first heat-resistant bag in a folded state; and in FIG. 1(1D), 122 denotes the first heat-resistant bag in an expanded state.

The first heat-resistant bag 121 in a folded state illustrated in FIG. 1(1C) and the first heat-resistant bag 122 in an expanded state illustrated in FIG. 1(1D) can be, for example, produced by the following method.

A first heat-resistant bag front member 101 and a first heat-resistant bag rear member 102 are prepared from a container-forming material having a heat seal layer. In FIG. 1(1A), the first heat-resistant bag front member 101 has a rectangular shape constituted by a first heat-resistant bag front member first side portion 101a and a first heat-resistant bag front member second side portion 101b; the first heat-resistant bag rear member 102 has a rectangular shape constituted by a first heat-resistant bag rear member first side portion 102a and a first heat-resistant bag rear member second side portion 102b; the first heat-resistant bag front member first side portion 101a and the first heat-resistant bag rear member first side portion 102a have the same length; and the first heat-resistant bag front member second side portion 101b and the first heat-resistant bag rear member second side portion 102b have the same length.

From the container-forming material having a heat seal layer, a first heat-resistant bag bottom member 103 is prepared. In FIG. 1(1A), a first heat-resistant bag bottom member first side portion 103a of the first heat-resistant bag bottom member 103 has the same length as the first heat-resistant bag front member first side portion 101a of the first heat-resistant bag front member 101 and the first heat-resistant bag rear member first side portion 102a of the first heat-resistant bag rear member 102.

In FIG. 1, the shapes of the first heat-resistant bag front member 101, the first heat-resistant bag rear member 102, and the first heat-resistant bag bottom member 103 are merely one example, and the shape and the size can vary according to the shape, volume, etc., of the first heat-resistant bag to be formed.

As illustrated in FIG. 1(1A), the first heat-resistant bag front member 101 and the first heat-resistant bag rear member 102 are arranged so that the heat seal layers face each other, and the first heat-resistant bag bottom member 103 folded in two so that the substrate layers contact each other is inserted between these members to form a stack of these members.

In stacking, the first heat-resistant bag front member 101, the first heat-resistant bag rear member 102, and the first heat-resistant bag bottom member 103 are arranged so that
the first heat-resistant bag front member first side portion 101a, the first heat-resistant bag rear member first side portion 102a, and a first heat-resistant bag bottom member first side portion 103a overlap one another and
the first heat-resistant bag front member second side portion 101b, the first heat-resistant bag rear member second side portion 102b, and a first heat-resistant bag bottom member folding line end portion 103c of a first heat-resistant bag bottom member folding line 103b in the first heat-resistant bag bottom member 103 overlap one another.

Next, as illustrated in FIG. 1(1B), a stack of the first heat-resistant bag front member 101, the first heat-resistant bag rear member 102, and the first heat-resistant bag bottom member 103 is heat-sealed so as to provide a heat seal portion 110 that includes the first heat-resistant bag bottom member first side portion 103a and the first heat-resistant bag front member second side portion 101b and that has a desired width and an oblique heat seal portion 111 that starts from the first heat-resistant bag bottom member folding line end portion 103c, intersects the first heat-resistant bag front member second side portion 101b at an intersection angle θ, and has a desired width to thereby obtain a heat-resistant bag preform 120.

Next, a cutting process is conducted along a cutting line C in the oblique heat seal portion 111 illustrated in FIG. 1(1B) to cut away unneeded portion 130 to form a first heat-resistant bag 121 in a folded state as illustrated in FIG. 1(1C). Subsequently, the first heat-resistant bag 121 in a folded state is expanded to obtain a first heat-resistant bag 122 in an expanded state illustrated in FIG. 1 (1D).

By cutting away the unneeded portion 130 as the unneeded part, it becomes possible for the first heat-resistant bag 122 in an expanded state illustrated in FIG. 1(1D) to have a flat bottom. In this manner, the first heat-resistant bag 122 in an expanded state gains self-supporting properties and the area of the bottom can be increased; thus, when placed on a metal plate, frying pan, pot, or the like sufficiently heated by direct fire or the like, the contact area can be increased, and thus the heating efficiency for the interior of the heat-resistant bag can be increased.

In the first heat-resistant bag illustrated in FIG. 1, by constituting at least the first heat-resistant bag front member 101 and the first heat-resistant bag rear member 102 by a transparent container-forming material, the inside of the first heat-resistant bag can be made visible and, when the bag is used as a cooking bag, the convenience can be increased. In addition, by constituting the first heat-resistant bag bottom member 103 by a container-forming material containing paper or a metal such as an aluminum foil as a substrate, the heat-resistant bag can be prevented from fusion-bonding to a heated metal plate, frying pan, pot, etc. Furthermore, by constituting the first heat-resistant bag bottom member 103 by a container-forming material containing a metal such as an aluminum foil as a substrate, heat of the heated metal plate, frying pan, pot, etc., can be efficiently transmitted to the inside of the heat-resistant bag.

FIG. 2 includes schematic diagrams illustrating formation of a second heat-resistant bag according to an embodiment of the heat-resistant container of the present invention by heat sealing. In FIG. 2(2A), 201 denotes a second heat-resistant bag front member, 202 denotes a second heat-resistant bag rear member, 203 denotes a second heat-resistant bag bottom member, 204 denotes a second heat-resistant bag first side surface member, and 205 denotes a second heat-resistant bag second side surface member; in FIG. 2 (2B), 210 denotes a second heat-resistant bag heat seal portion and 220 denotes the second heat-resistant bag in a folded state; and in FIG. 2(2C), 221 denotes the second heat-resistant bag in an expanded state.

The second heat-resistant bag 220 in a folded state illustrated in FIG. 2(2B) and the second heat-resistant bag 221 in an expanded state illustrated in FIG. 2(2C) can be, for example, produced by the following method.

A second heat-resistant bag front member 201 and a second heat-resistant bag rear member 202 are prepared from a container-forming material having a heat seal layer. In FIG. 2 (2A), the second heat-resistant bag front member 201 has a rectangular shape constituted by a second heat-resistant bag front member first side portion 201a and a second heat-resistant bag front member second side portion 201b; the second heat-resistant bag rear member 202 has a rectangular shape constituted by a second heat-resistant bag rear member first side portion 202a and a second heat-resistant bag rear member second side portion 202b; the second heat-resistant bag front member first side portion 201a and the second heat-resistant bag rear member second side portion 202a have the same length; and the second heat-resistant bag front member second side portion 201b and the second heat-resistant bag rear member second side portion 202b have the same length.

From the container-forming material having a heat seal layer, a second heat-resistant bag bottom member 203 is prepared. In FIG. 2(2A), a second heat-resistant bag bottom member first side portion 203a of the second heat-resistant bag bottom member 203 has the same length as the second heat-resistant bag front member first side portion 201a of the second heat-resistant bag front member 201 and the second heat-resistant bag rear member first side portion 202a of the second heat-resistant bag rear member 202.

Furthermore, a second heat-resistant bag first side surface member 204 and a second heat-resistant bag second side surface member 205 are prepared from a container-forming material having a heat seal layer. In FIG. 2 (2A), a second heat-resistant bag first side surface member first side portion 204a and the second heat-resistant bag second side surface member first side portion 205a have the same length as the second heat-resistant bag front member second side portion 201b and the second heat-resistant bag rear member second side portion 202b.

In FIG. 2, the shapes of the second heat-resistant bag front member 201, the second heat-resistant bag rear member 202, the second heat-resistant bag bottom member 203, the second heat-resistant bag first side surface member 204, and the second heat-resistant bag second side surface member 205 are merely one example, and the shape and the size can vary according to the shape, volume, etc., of the heat-resistant bag to be formed.

As illustrated in FIG. 2(2A), the second heat-resistant bag front member 201 and the second heat-resistant bag rear member 202 are arranged so that the heat seal layers face each other, and, during this operation, the second heat-resistant bag bottom member 203 folded in two so that the substrate layers contact each other, the second heat-resistant bag first side surface member 204 that is folded in two so that the substrate layers contact each other, and that has a first folded-back portion 206 at one side of the second heat-resistant bag first side surface member first side portion 204a, and the second heat-resistant bag second side surface member 205 that is folded in two so that the substrate layers contact each other, and that has a second folded-back portion 207 at one side of the second heat-resistant bag second side surface member first side portion 205a are inserted between the members 201 and 202 so as to form a stack of these members. During this operation, the second heat-resistant bag bottom member 203 is arranged such that a second heat-resistant bag bottom member folding line 203b fits into the first folded-back portion 206 and the second folded-back portion 207.

When stacked, the second heat-resistant bag front member 201, the second heat-resistant bag rear member 202, the second heat-resistant bag bottom member 203, the second heat-resistant bag first side surface member 204, and the second heat-resistant bag second side surface member 205 are arranged such that
the second heat-resistant bag front member first side portion 201a, the second heat-resistant bag rear member first side portion 202a, and the second heat-resistant bag bottom member first side portion 203a overlap one another,
the intersection between the second heat-resistant bag front member first side portion 201a and the second heat-resistant bag front member second side portion 201b overlaps the second heat-resistant bag first side surface member first side end portion 204b,
the second heat-resistant bag front member second side portion 201b, the second heat-resistant bag rear member second side portion 202b, the second heat-resistant bag bottom member folding line end portion 203c, the second heat-resistant bag first side surface member first side portion 204a, and the first folded-back portion end portion 206a overlap one another,
the intersection between the second heat-resistant bag front member first side portion 201a and the second heat-resistant bag front member second side portion 201b overlaps the second heat-resistant bag second side surface member first side end portion 205b, and
the second heat-resistant bag front member second side portion 201b, the second heat-resistant bag rear member second side portion 202b, the second heat-resistant bag bottom member folding line end portion 203c, the second heat-resistant bag second side surface member first side portion 205a, and the second folded-back portion end portion 207a overlap one another.

Next, as illustrated in FIG. 2(2B), a stack that includes the second heat-resistant bag front member 201, the second heat-resistant bag rear member 202, the second heat-resistant bag bottom member 203, the second heat-resistant bag side surface member 204, and the second heat-resistant bag side surface member 205 is heat-sealed so that a second heat-resistant bag heat seal portion 210 having a desired width is formed in a section that includes the second heat-resistant bag front member first side portion 201a, the second heat-resistant bag rear member first side portion 202a and the second heat-resistant bag bottom member first side portion 203a, the second heat-resistant bag front member second side portion 201b, the second heat-resistant bag rear member second side portion 202b, and the second heat-resistant bag first side surface member first side portion 204a and in a section that includes the second heat-resistant bag front member second side portion 201b, the second heat-resistant bag rear member second side portion 202b, and the second heat-resistant bag second side surface member first side portion 205a, thereby creating a second heat-resistant bag 220 in a folded state. The second heat-resistant bag 220 in a folded state is expanded to obtain a second heat-resistant bag 221 in an expanded state illustrated in FIG. 2 (2C).

In the heat-resistant bag of the form illustrated in FIG. 2, by constituting at least the second heat-resistant bag front member 201 and the second heat-resistant bag rear member 202 by a transparent container-forming material, the inside of the heat-resistant bag can be made visible and, when the bag is used as a cooking bag, the convenience can be increased. In addition, by constituting the second heat-resistant bag bottom member 203 by a container-forming material containing paper or a metal such as an aluminum foil as a substrate, the heat-resistant bag can be prevented from fusion-bonding to a heated metal plate, frying pan, pot, etc. Furthermore, by constituting the second heat-resistant bag bottom member 203 by a container-forming material containing a metal such as an aluminum foil as a substrate, heat of the heated metal plate, frying pan, pot, etc., can be efficiently transmitted to the inside of the heat-resistant bag.

FIG. 3 includes schematic diagrams illustrating a heat-resistant bag according to one embodiment of the heat-resistant container of the present invention and formation of the heat-resistant bag by heat sealing. In FIG. 3(3A), 301 denotes a third heat-resistant bag member constituted by a heat-resistant bag-forming material; in FIG. 3(3B), 310 denotes a third heat-resistant bag heat seal portion and 320 denotes a third heat-resistant bag in a folded state; and in FIG. 3(3C), 321 denotes the third heat-resistant bag in an expanded state.

Note that, the shape of the third heat-resistant bag member 301 and the folding width of the third heat-resistant bag member are merely one example, and the shape and size can vary according to the shape, volume, etc., of the heat-resistant bag to be formed.

The third heat-resistant bag 320 in a folded state illustrated in FIG. 3(3B) and the third heat-resistant bag 321 in an expanded state illustrated in FIG. 3(3C) can be, for example, produced by the following method.

A quadrilateral third heat-resistant bag member 301 having a heat seal layer is folded in a W shape (inverted M shape) with the heat seal layer on the inner side. For example, a rectangular container-forming material is folded in half so that the substrate layers face each other, and then is symmetrically folded in a direction opposite to the folding direction at the center so that a desired bottom area is created and thus the third heat-resistant bag member 301 assumes a W shape (inverted M shape).

Next, in the third heat-resistant bag member 301 folded into a W shape (inverted M shape), as illustrated in FIG. 3(3B), end portions that include side portions where the folds are made are heat-sealed to form a third heat-resistant bag heat seal portion 310 and to thereby form a third heat-resistant bag in a folded state. The third heat-resistant bag 320 in a folded state is expanded to obtain a third heat-resistant bag 321 in an expanded state illustrated in FIG. 3(3C).

In the third heat-resistant bag illustrated in FIG. 3, no heat seal portion exists at the heat-resistant bag bottom contacting the heated metal plate, frying pan, pot, or the like, and thus the bottom contact area can be increased and, during heating, occurrence of separation of the heat seal portion can be suppressed. Furthermore, the third heat-resistant bag illustrated in FIG. 3 can be prepared by a simple method.

FIG. 4 is a schematic diagram of a heat-resistant dish according to one embodiment of the heat-resistant container according to the present invention. In FIG. 4, 421 denotes a heat-resistant dish. The heat-resistant dish 421 can be produced by the following method, for example.

A container-forming material having a heat seal layer and cut into a predetermined size is indirectly heated with a far-infrared irradiation heater to be softened, is rapidly placed on, for example, a lower die of a deep drawing machine, and is retained for a predetermined time while an upper die is lowered from above the container-forming material so as to form a heat-resistant dish of a particular size. Subsequently, the peripheral portion is cut as necessary so that a heat-resistant dish 421 illustrated in FIG. 4 can be obtained.

### <Applications of Heat-Resistant Container>

The applications of the heat-resistant container are not particularly limited. Utilizing the heat-resistant properties of the container, the heat-resistant container is preferably used as a container for heating articles, materials, etc., inside the container. An example is cooking applications for heating and cooking the ingredients placed in the heat-resistant container. Examples of using the heat-resistant container in cooking applications include cooking bag applications with which deep-frying using heated oil is carried out in a heat-resistant bag, which is a bag-shaped heat-resistant container.

When deep-frying is carried out by using a heat-resistant bag which is a bag-shaped heat-resistant container, the heat-resistant bag can be placed on a heating source, such as a heated iron plate, frying pan, pot, oven, or the like. In such a case, the heat-resistant bag is preferably a bag with a bottom so that the heat-resistant bag can be stably placed on a heating source such as a heated iron plate, frying pan, pot, oven, or the like. For example, a heat-resistant bag having a flat bottom such as the ones illustrated in FIGS. 1(1D), 2(2C), and 3(3C) can be used. In this manner, the efficiency of heating the ingredients and cooking liquid (frying oil and the like) inside the heat-resistant bag can be improved, and the heat-resistant bag can be stably placed on a heating source such as a heated iron plate, frying pan, pot, oven, or the like; thus, troubles such as tumbling of the heat-resistant bag and spilling of the heated cooking liquid (heated frying oil etc.) can be suppressed.

When the heat-resistant bag has a bottom, in order to prevent softening of the heat-resistant bag by overheating and prevent fusion bonding of the heat-resistant bag onto the heating source such as a heated iron plate, frying pan, pot, oven, or the like, a laminate that includes a highly heat resistant paper, metal (aluminum foil or the like), or the like as a substrate is preferably used in the container constituting the bottom. Furthermore, in order to make the state of progress of cooking visible during cooking, such as deep-frying, a desired portion, for example, the entire heat-resistant container or a portion other than the bottom of the heat-resistant container, may be constituted by a (semi)transparent container-forming material.

### [Cooking Method]

A cooking method according to the present invention involves performing cooking by using the aforementioned heat-resistant container. Examples of the heat-resistant container include a bag-shaped heat-resistant bag or a dish-shaped heat-resistant dish. Here, the heat-resistant bag is a cooking bag, and the heat-resistant dish is a cooking dish.

Hereinafter, a cooking method that uses a cooking bag is described as one embodiment.

FIG. 5 is a schematic diagram of cooking that uses a heat-resistant bag, which is a bag-shaped heat-resistant container illustrated in FIG. 1(1D), as a cooking bag. In FIG. 5, 501 denotes a cookware, 510 denotes a heating means (in FIG. 5, direct fire), 520 denotes a cooking bag, 530 denotes an ingredient, and 531 denotes a condiment·cooking liquid. In FIG. 5, a frying pan is used as the cookware; alternatively, a pot, an iron plate, an IH cooking heater, an oven, etc., can be used.

The cookware 501 is heated by the heating means 510 and heats the cooking bag 520 placed on the cookware 501.

The cooking bag 520 has an opening 521 used to place the ingredient 530, the condiment·cooking liquid 531, etc., into the cooking bag 520 and to take out the cooked food after completion of the cooking.

In the cooking method that uses the cooking bag 520, the ingredient 530 and the condiment·cooking liquid 531 may be placed inside the cooking bag 520 in advance. The ingredient 530 may be anything that can be cooked (materials to be cooked). An example is ingredients (at least one selected from the group consisting of meat, seafood, vegetables, processed grains such as noodles, rice, etc.) of any desired shape. These ingredients may be subjected to a heating process or the like in advance. The condiment·cooking liquid 531 may be anything that is used for cooking the ingredient (materials to be cooked), and an example thereof is at least one selected from the group consisting of water, edible oil, bouillon, soy sauce, sake, sugar, salt, fry powder, spices, etc.

The cooking bag 520 housing the ingredient 530, the condiment·cooking liquid 531, etc., may have the opening 521 sealed by heat seal or the like. In such a case, it is possible to directly sell the bag or package the bag with a packaging bag or the like so that the bag itself can be sold as a merchandise. In such a case, the opening 521 can be formed by opening the opening 521 along the heat seal portion at the start of or after the end of cooking.

When the ingredient 530 or the condiment·cooking liquid 531 are not stored in the cooking bag 520 in advance or when only the condiment·cooking liquid 531 are stored, the user puts the ingredient 530 into the cooking bag 520 through the opening 521. Moreover, when the condiment·cooking liquid are already placed in the cooking bag 520, the user can put the ingredient 530 into the cooking bag 520 and then, for example, rub or shake the cooking bag 520 from outside so that the added ingredient 530 blends with the condiment·cooking liquid 531. In doing so, by bending down the upper portion of the cooking bag 520 (by closing and folding the opening 521), the cooking bag 520 can be easily re-closed due to the dead hold properties of the heat seal layer constituting the innermost layer. As a result, spilling of the ingredient 530 and the condiment·cooking liquid 531 from the cooking bag 520 can be suppressed.

Here, an example of a cooking method for preparing fried chicken by using the cooking bag 520 is described.

Chicken pieces cut into appropriate size serving as the ingredient 530 and a fry powder and the like serving as the condiment·cooking liquid 531 are put in the cooking bag 520 and blended by rubbing the cooking bag 520 from outside.

Next, edible oil serving as the condiment·cooking liquid 531 is put into the cooking bag 520 to complete preparation of the cooking. Examples of the edible oil put here include canola oil and salad oil. The amount of the edible oil put can be freely adjusted, and, for example, may be an amount at which the ingredients put therein are all immersed.

Next, the prepared cooking bag 520 is heated by a heating means. The heating means is not particularly limited, and examples thereof include methods such as placing the cooking bag with the bottom contacting a metal plate, frying pan, pot, or the like sufficiently heated by direct fire or with an IH heater, placing the bag in a preheated oven, and heating the bag in an oven. For example, FIG. 5 illustrates a method in which a prepared cooking bag 520 is placed on a cookware 501 on a heating means 510 which is direct fire.

During heating, it is preferable to appropriately stir to prevent the chicken pieces, which are the ingredient 530, from coming together (sticking or adhering). By heating at an appropriate heating temperature for an appropriate length of time, the heat of the edible oil cooks the chicken, which is the ingredient 530, and deep fried food (fried chicken) is ready. Then the deep-fried food (fried chicken) is taken out of the cooking bag 520, and the cooking is completed. Alternatively, the cooking may be completed by discharging the condiment·cooking liquid 531, such as edible oil, from the cooking bag 520.

After completion of the cooking, the used edible oil may be disposed of as waste oil. In doing so, the edible oil inside the cooking bag 520 can be easily disposed of by cooling the edible oil used in the cooking bag 520 for an appropriate length of time and then adding a waste oil treating agent or the like to the cooking bag 520, for example.

According to the cooking method of the present invention, the greasy dirt on the cookware 501 etc., is reduced, and thus the trouble of cleaning after the cooking can be greatly reduced.

In the present invention, the crystallinity of the crystalline polyester-based resin in the heat seal layer and the substrate layer in the container-forming material constituting the cooking bag 520 can be increased by heating during cooking, and as a result, the rigidity of the cooking bag 5220 can be improved. Moreover, depending on the type of the food to be cooked, the cooking bag 520 can be directly used as tableware.

Although an example of the cooking method that uses the cooking bag 520 is illustrated in FIG. 5, the cooking method of the present invention may be implemented by using the cooking dish 421 illustrated in FIG. 4. For example, cooking may be performed by, a method that involves placing the ingredient on the cooking dish 421 and placing the cooking dish 421 with the bottom contacting a metal plate, frying pan, pot, or the like sufficiently heated by direct fire or with an IH heater, or the like, placing the dish in a preheated oven, or heating the dish in an oven.

In the cooking method of the present invention, the heat-resistant container may be free of metal so that cooking (heating) using a microwave oven is also possible.

An example of the cooking method of the present invention is a technique of heating a heat-resistant container containing the ingredient and the like in an oven. The heat-resistant container of the present invention, which has heat resistance, is extremely suitable for oven cooking that involves heating the ingredient and the like in a high-temperature chamber. In such a case, the substrate layer in the laminate is not particularly limited as long as the material can withstand the temperature during the cooking but is particularly preferably a metal foil or paper having excellent heat resistance.

### EXAMPLES

The examples of the present invention will now be described, but the present invention is not limited to these examples.

In Examples 1 to 21 and Comparative Examples 1 to 3 (Tables 1 to 3), the blend amounts of the constituent components are parts by mass.

### [Constituent Component·Constituent Material]

In Examples 1 to 21 and Comparative Examples 1 to 3, the constituent component·constituent material used in constituting the container-forming material are as follows.

### <Resin>

PET1: Polyethylene terephthalate-based resin (produced by LEALEA ENTERPRISE CO., LTD., “S103”, intrinsic viscosity=0.80 dl/g)
PET2: Polyethylene terephthalate-based resin (produced by UNITIKA LTD., “MA-2101M”, intrinsic viscosity=0.62 dl/g)
PP: Polypropylene resin (produced by SunAllomer Ltd., “PC480A”, MFR=2.0 g/10 minutes)
St-GM: Epoxy group-containing styrene-(meth)acrylic acid ester-based resin (produced by BASF Japan, “JONCRYL ADR-4368-CS”)
PBT: Polybutylene terephthalate-based resin (produced by Polyplastics Co., Ltd., “500FP”, intrinsic viscosity=0.875 dl/g)

### <Substrate Layer>

oPET: Biaxially stretched polyester film (produced by TOYOBO CO., LTD., “E5102”, thickness: 12 μm or 25 μm)
Paper1: High quality paper (produced by Hokuetsu Corporation, “Kishu high quality paper N”, grammage=64 g/m²)
Paper2: High quality paper (produced by Hokuetsu Corporation, “Kishu high quality paper N”, grammage=157 g/m²)
AL: “N8021 material” (produced by TOYO ALUMINIUM K.K., aluminum foil, thickness=7 μm)

### [Evaluation]

In Examples 1 to 21, and Comparative Examples 1 to 3, the heat seal layer film-forming properties of the obtained heat seal layer-forming resin composition, the container-forming properties of the obtained container-forming material, the oil-proofing properties (oil retaining properties) of the obtained heat-resistant container (heat-resistant bag), and crispiness were evaluated as follows.

Note that in Comparative Examples 1 and 2, the container could not be formed, and in Comparative Example 3, oil leaked and cooking could not be performed.

### <Heat Seal Layer Film Forming Properties>

A: The neck-in amount at two ends of a film discharged from a die having a width of 400 mm is less than 25 mm, the number of gels or fish-eyes equal to or more than 0.5 mmφ and less than 1.5 mmφ per 1 m² of the film is less than 5, and there are no gels or fish-eyes equal to or more than 1.5 mmφ.
B: The neck-in amount at two ends of a film discharged from a die having a width of 400 mm is 25 mm or more and less than 75 mm. Alternatively, the number of gels or fish-eyes equal to or more than 0.5 mmφ and less than 1.5 mmφ per 1 m² of the film is 5 or more, and there are one or more gels or fish-eyes equal to or more than 1.5 mmφ.
C: Discharge was not possible due to increased viscosity. Alternatively, the neck-in amount at two ends of a film discharged from a die having a width of 400 mm is 75 mm or more.

Note that the neck-in amount discussed here was calculated from the following equation where WD is the width of the die and W is the discharged film width.

Neck-in amount [mm]=(WD−W)/2

In the present invention, A and B indicate pass, and C indicates fail.

### <Container-Forming Properties>

### (Heat Seal Properties of Heat-Resistant Bag)

A: A seal strength of 3N/15 mm or more is exhibited per heat seal width of 15 mm at 140 °C, 1 second, and 0.2 MPa.
B: A seal strength of less than 3N/15 mm is exhibited per heat seal width of 15 mm at 140 °C, 1 second, and 0.2 MPa.

### (Deep-Drawability of Heat-Resistant Dish)

A: No breakage or tear occurred.
B: Breakage and/or tear occurred.

In the present invention, A indicates pass, and B indicates fail.

### <Oil-Proofing Properties (Oil Retaining Properties)>

From the opening of the obtained heat-resistant container, 100 g of chicken powdered with a commercially available frying powder was placed, and 150 mL of a commercially available salad oil was poured. Next, the entire heat-resistant container was placed on a frying pan and heated with medium heat for 10 minutes.

Leakage of the salad oil when the heat-resistant container was lifted up from the frying pan and the leakage of the salad oil on a ceramic plate when the heat-resistant container was moved to a ceramic plate were checked and evaluated according to the following standard.
A: From the start of heating and to moving the heat-resistant container to the ceramic plate, the oil can be securely maintained inside the heat-resistant container.
B: From the start of heating and to moving the heat-resistant container to the ceramic plate, the oil slightly leaks from the heat-resistant container.
C: From the start to finish of the heating, much oil leaks from the heat-resistant container onto the frying pan.

In the present invention, A and B indicate pass, and C indicates fail.

### <Crispiness>

The prepared fried chicken was taken out of the cooking container after cooking, and a testing subject conducted taste test and evaluated the crispiness of the surface of the fried chicken according to the following standard. The results are indicated in Tables 1 to 3. Here, crispiness is the texture of the fried chicken and indicates the feel of pleasant crunchiness.
A: There is a feel of pleasant crunchiness.
B: There is no feel of crunchiness.

In the present invention, A indicates pass, and B indicates fail.

### Example 1

A heat seal layer-forming resin composition was prepared by mixing 100 parts by mass of PET1 and 0.1 parts by mass of St-GM using a Henschel mixer for 5 minutes.

The obtained heat seal layer-forming resin composition was placed in a T-die film-forming machine equipped with a 40 mmφ, L/D=31 Dulmage screw and a 40 μm-thick heat seal layer was formed at a die temperature of 285 °C. Immediately before the formed heat seal layer contacted the cooling roll, oPET was inserted as a substrate layer, the heat seal layer and the substrate layer were press-bonded, and a container-forming material having a heat seal layer/substrate layer structure was prepared by an extrusion lamination method.

Two pieces of the obtained container-forming materials cut to 150 mm×160 mm were prepared for use as the front·rear parts of a heat-resistant bag. In addition, the obtained container-forming material cut to 150 mm×90 mm was used as the bottom part of the heat-resistant bag. As illustrated in FIG. 1, the front member and the rear member were arranged so that the heat seal layers faced each other, and the heat-resistant bag bottom member folded in two was inserted and stacked therebetween so that the substrate layers contact each other to form a stack of these members. Next, an impulse sealer was used to heat-seal the predetermined positions such as end portions and the like to thereby form a heat seal portion of a desired width, the unneeded portion was cut away, and a heat-resistant container (heat-resistant bag) having an opening illustrated in FIG. 1(1D) was prepared thereby.

The heat seal layer film-forming properties of the obtained heat seal layer-forming resin composition, the container-forming properties of the obtained container-forming material, the oil-proofing properties (oil retaining properties) of the obtained heat-resistant container (heat-resistant bag), and crispiness were evaluated. The results are indicated in Table 1.

### Examples 2 to 15 and Comparative Examples 1 to 3

A heat seal layer-forming resin composition was prepared as in Example 1 except that the heat seal layer composition and the heat seal layer thickness were as indicated in Tables 1 and 2.

A container-forming material having a heat seal layer/substrate layer structure was prepared as in Example 1 except that the substrate layer was as indicated in Tables 1 and 2.

A heat-resistant container (heat-resistant bag) was prepared as in Example 1 by using the obtained container-forming material.

The heat seal layer film-forming properties of the obtained heat seal layer-forming resin composition, the container-forming properties of the obtained container-forming material, and the oil-proofing properties (oil retaining properties) of the obtained heat-resistant container (heat-resistant bag), and crispiness were evaluated. The results are indicated in Table 1.

### Example 16

A heat-resistant container (heat-resistant bag) was prepared as in Example 1 by using the container-forming material used in Example 1 as the front member 1 and the rear member 2 and by using the container-forming material used in Example 3 as the bottom member 3.

### Examples 17 and 18

A heat seal layer-forming resin composition was prepared as in Example 1 except that the heat seal layer composition and the heat seal layer thickness were as indicated in Table 3.

A container-forming material that had a heat seal layer/anchor coat agent application layer/substrate layer structure was prepared by an extrusion lamination method as in Example 1 except that an oPET or aluminum foil (AL) having one surface on which a two-component-type polyurethane-based anchor coat agent (produced by Mitsui Chemicals, Inc., “TAKELAC A-3210/TAKENATEA-3075”) was applied and dried was used as the substrate layer.

A heat-resistant container (heat-resistant container of the first embodiment; heat-resistant bag) was prepared as in Example 1 by using the obtained container-forming material.

### Example 19

A heat seal layer-forming resin composition was prepared as in Example 1 except that the heat seal layer composition and the heat seal layer thickness were as indicated in Table 3.

The obtained heat seal layer-forming resin composition was placed in a T-die film-forming machine equipped with a 40 mmφ, L/D=31 Dulmage screw, and a 40 μm-thick heat seal layer was formed at a die temperature of 285 °C and brought into contact with a cooling roll to prepare a film of the heat seal layer-forming resin composition.

A container-forming material having a heat seal layer/dry lamination-use adhesive layer/substrate layer structure was prepared by dry lamination by using, as a substrate, an oPET having one surface on which a two-component curable polyurethane-based adhesive (produced by ROCK PAINT Co., Ltd., “RU-40/H-4”, dry lamination-use adhesive) was applied and dried, stacking the prepared film on the adhesive-coated surface of the substrate layer, and performing press-bonding with a heating roll.

A heat-resistant container (heat-resistant container of the first embodiment; heat-resistant bag) was prepared as in Example 1 by using the obtained container-forming material.

### Examples 20 and 21

A heat seal layer-forming resin composition was prepared as in Example 1 except that the heat seal layer composition and the heat seal layer thickness were as indicated in Table 3.

A container-forming material having a heat seal layer/substrate layer structure was prepared as in Example 1 except that the substrate layer was as indicated in Table 3.

The obtained container-forming material cut into 300 mm×300 mm was indirectly heated with a far-infrared irradiation heater to soften the container-forming material and was rapidly placed on a die of a tabletop-type plug-assist molding machine, and a die was lowered from above the container-forming material and held in this state for 30 seconds to form a round dish-type container having a diameter of 100 mm and the deepest portion of 30 mm. Next, the container was cut by leaving a 10 mm-width flange portion from the peripheral portion so as to prepare a heat-resistant container (heat-resistant container of the fourth embodiment, heat-resistant dish).

TABLE 1

| | | Examples | | | | | | | |
|---|---|---|---|---|---|---|---|---|---|
| | | 1 | 2 | 3 | 4 | 5 | 6 | 7 | 8 |
| Heat seal layer | PET1 | 100 | 100 | 100 | 100 | 100 | 100 | 100 | 100 |
| composition | PET2 | | | | | | | | |
| | PP | | | | | | | | |
| | St-GM | 0.10 | 0.10 | 0.10 | 0.10 | 0.26 | 0.26 | 0.26 | 0.26 |
| | PBT | | | | | | | 5 | 5 |
| Heat seal layer thickness (μm) | | 40 | 40 | 40 | 40 | 40 | 40 | 40 | 40 |
| Substrate layer | Material | oPET | oPET | Paper1 | Paper2 | oPET | Paper1 | oPET | Paper1 |
| | Thickness (μm) | 12 | 25 | | | 12 | | 12 | |
| | Grammage (g/m²) | | | 64 | 157 | | 64 | | 64 |
| Bonding method | | EX | EX | EX | EX | EX | EX | EX | EX |
| Evaluation | Heat seal layer film forming | A | A | A | A | A | A | A | A |
| | properties | | | | | | | | |
| | Container-forming properties | A | A | A | A | A | A | A | A |
| | Oil-proofing properties (oil | A | A | A | A | A | A | A | A |
| | retaining properties) | | | | | | | | |
| | Crispiness | A | A | A | A | A | A | A | A |

TABLE 2

| | | Examples | | | | | | | |
|---|---|---|---|---|---|---|---|---|---|
| | | 9 | 10 | 11 | 12 | 13 | 14 | 15 | 16 |
| Heat seal layer | PET1 | 100 | 100 | 100 | 100 | 100 | 100 | | |
| composition | PET2 | | | | | | | 100 | |
| | PP | | | | | | | | |
| | St-GM | 0.26 | 0.26 | 0.50 | 0.50 | 0.26 | 0.26 | 0.10 | |
| | PBT | 10 | 30 | 10 | 30 | | 10 | | |
| Heat seal layer thickness (μm) | | 40 | 40 | 40 | 40 | 80 | 80 | 40 | |
| Substrate layer | Material | oPET | oPET | oPET | oPET | oPET | oPET | oPET | |
| | Thickness (μm) | 12 | 12 | 12 | 12 | 12 | 12 | 12 | |
| | Grammage (g/m²) | | | | | | | | |
| Bonding method | | EX | EX | EX | EX | EX | EX | EX | |
| Evaluation | Heat seal layer film forming | A | A | B | B | A | A | B | |
| | properties | | | | | | | | |
| | Container-forming properties | A | B | A | B | A | A | A | A |
| | Oil-proofing properties (oil | A | A | A | A | B | B | A | A |
| | retaining properties) | | | | | | | | |
| | Crispiness | A | A | A | A | A | A | A | A |

TABLE 3

| | | | | | | | Comparative | | |
|---|---|---|---|---|---|---|---|---|---|
| | | Examples | | | | | Examples | | |
| | | 17 | 18 | 19 | 20 | 21 | 1 | 2 | 3 |
| Heat seal layer | PET1 | 100 | 100 | 100 | 100 | 100 | 100 | 100 | |
| composition | PET2 | | | | | | | | |
| | PP | | | | | | | | 100 |
| | St-GM | 0.10 | 0.10 | 0.10 | 0.26 | 0.26 | 1.00 | | |
| | PBT | | | | | 10 | 30 | | |
| Heat seal layer thickness (μm) | | 40 | 40 | 40 | 80 | 80 | 40 | 40 | 40 |
| Substrate layer | Material | oPET | AL | oPET | oPET | oPET | oPET | oPET | oPET |
| | Thickness (μm) | 12 | 9 | 12 | 12 | 12 | 12 | 12 | 12 |
| | Grammage (g/m²) | | | | | | | | |
| Bonding method | | ACEX | ACEX | DL | EX | EX | EX | EX | EX |
| Evaluation | Heat seal layer film forming | A | A | A | A | A | C | C | A |
| | properties | | | | | | | | |
| | Container-forming | A | A | A | A | A | — | — | A |
| | properties | | | | | | | | |
| | Oil-proofing properties (oil | A | A | A | A | A | — | — | C |
| | retaining properties) | | | | | | | | |
| | Crispiness | A | A | A | A | A | — | — | — |

According to the present invention, there is provided a heat-resistant container that has such heat resistance that the container can be placed on a cookware such as a pot or a frying pan directly on the stove and cooking such as stir-frying or deep-frying can be easily carried out, and that can save the trouble of washing the cookware, cleaning the kitchen, and disposing of waste oil after deep-frying. As a result, cooking such as stir-frying or deep-frying can be easily carried out. Moreover, original recipes can be used in cooking without being bound by ready-made recipes.

Furthermore, the heat-resistant container can be directly used as dinnerware on the table.

### REFERENCE SIGNS LIST

101 first heat-resistant bag front member
101a first heat-resistant bag front member first side portion
101b first heat-resistant bag front member second side portion
102 first heat-resistant bag rear member
102a first heat-resistant bag rear member first side portion
102b first heat-resistant bag rear member second side portion
103 first heat-resistant bag bottom member
103a first heat-resistant bag bottom member first side portion
103b first heat-resistant bag bottom member folding line
103c first heat-resistant bag bottom member folding line end portion
8 intersection angle
110 end portion heat seal portion
111 oblique heat seal portion
120 heat-resistant bag preform
121 first heat-resistant bag in a folded state
122 first heat-resistant bag in an expanded state
130 unneeded portion
C cutting line
201 second heat-resistant bag front member
201a second heat-resistant bag front member first side portion
201b second heat-resistant bag front member second side portion
202 second heat-resistant bag rear member
202a second heat-resistant bag rear member first side portion
202b second heat-resistant bag rear member second side portion
203 second heat-resistant bag bottom member
203a second heat-resistant bag bottom member first side portion
203b second heat-resistant bag bottom member folding line
203c second heat-resistant bag bottom member folding line end portion
204 second heat-resistant bag first side surface member
204a second heat-resistant bag first side surface member first side portion
204b second heat-resistant bag first side surface member first side end portion
204c second heat-resistant bag first side surface member folding line
204d second heat-resistant bag first side surface member folding line end portion
205 second heat-resistant bag second side surface member
205a second heat-resistant bag second side surface member first side portion
205b second heat-resistant bag second side surface member folding line
205c second heat-resistant bag second side surface member folding line end portion
206 first folded-back portion
206a first folded-back portion end portion
207 second folded-back portion
207a second folded-back portion end portion
210 second heat-resistant bag heat seal portion
220 second heat-resistant bag in a folded state
221 second heat-resistant bag in an expanded state
301 third heat-resistant bag member
310 third heat-resistant bag heat seal portion
320 third heat-resistant bag in a folded state
321 third heat-resistant bag in an expanded state
421 heat-resistant dish
501 cookware
510 heating means (direct fire)
520 cooking bag
521 opening
530 ingredient
531 condiment·cooking liquid

1. A heat-resistant container at least part of which is constituted by a container-forming material having a heat seal layer, wherein
the heat seal layer contains a heat seal layer-forming resin composition, and
the heat seal layer-forming resin composition contains a crystalline polyethylene terephthalate-based resin and an epoxy group-containing styrene-(meth)acrylic acid ester-based resin, and a content of the epoxy group-containing styrene-(meth)acrylic acid ester-based resin relative to 100 parts by mass of the crystalline polyethylene terephthalate-based resin is 0.1 parts by mass or more and 0.9 parts by mass or less.

2. The heat-resistant container according to claim 1, wherein
the heat seal layer-forming resin composition contains a polybutylene terephthalate-based resin, and a content of the polybutylene terephthalate-based resin relative to 100 parts by mass of the crystalline polyethylene terephthalate-based resin is less than 30 parts by mass.

3. The heat-resistant container according to claim 1, wherein
the crystalline polyethylene terephthalate-based resin
has a crystal fusion peak temperature of 220 °C or more and 270 °C or less, and/or
has an intrinsic viscosity at 25 °C of 0.65 dl/g or more and 0.9 dl/g or less.

4. The heat-resistant container according to claim 1, wherein the container-forming material is a laminate having the heat seal layer and a substrate layer, and the substrate layer includes at least one layer selected from the group consisting of a biaxially stretched polyester-based resin layer, a paper layer, a metal vapor-deposited biaxially stretched polyester-based resin layer, and a metal foil layer.

5. A cooking method comprising performing cooking using the heat-resistant container according to claim 4.

6. The heat-resistant container according to claim 2, wherein
the crystalline polyethylene terephthalate-based resin
has a crystal fusion peak temperature of 220 °C or more and 270 °C or less, and/or
has an intrinsic viscosity at 25 °C of 0.65 dl/g or more and 0.9 dl/g or less.

7. The heat-resistant container according to claim 2, wherein the container-forming material is a laminate having the heat seal layer and a substrate layer, and the substrate layer includes at least one layer selected from the group consisting of a biaxially stretched polyester-based resin layer, a paper layer, a metal vapor-deposited biaxially stretched polyester-based resin layer, and a metal foil layer.
